(19) United States
(12) Patent Application Publication
(10) Pub. No.: US 2015/0171577 A1
(43) Pub. Date: Jun. 18, 2015

(54) MODULAR JACK HAVING POE LEADS SOLDERING ON AN OBLIQUE INNER PCB

(71) Applicant: FOXCONN INTERCONNECT TECHNOLOGY LIMITED, Grand Cayman (KY)

(72) Inventors: HAO HAN, Kunshan (CN); BING WANG, Kunshan (CN); BO HUANG, Kunshan (CN)

(21) Appl. No.: 14/569,773

(22) Filed: Dec. 14, 2014

(30) Foreign Application Priority Data
Dec. 13, 2013 (CN) 201310673680.9

(51) Int. Cl. H01R 24/64; H01R 13/405

(52) U.S. Cl. CPC H01R 24/64; H01R 13/405

(57) ABSTRACT

A modular jack includes an insulative housing, an oblique inner PCB mounted on the insulative housing, a number of mating contacts soldered to the top edge portion of the inner PCB, a number of footer pins soldered to the bottom edge portion of the inner PCB, and a number of POE leads soldered to the top edge portion. The contacts, footer pins, and POE leads are retained on the same piece insulative housing, thus omitting requirement of an insulative carrier and a process of assembling the footer pins and POE leads to the insulative carrier. Each of the contacts, footer pins, and POE leads has a connecting section extending along a same direction in order for the tail sections to be soldered on a same top face of the inner PCB by a one-time soldering process.

### BACKGROUND OF THE INVENTION

1. Field of the Invention

The present invention relates to a modular jack having an oblique inner printed circuit board (PCB), and more particularly to power-over-ethernet (POE) leads soldering to the inner PCB.

2. Description of Related Art

Chinese Patent No. CN202917709U, issued on May 1, 2013, discloses a modular jack having a rectangular insulative housing, a “Z” shaped insulative carrier assembled to the insulative housing, a plurality of terminals assembled to the insulative carrier, and an oblique inner PCB mounted onto the carrier.

Taiwan Patent No. TWM333702U, issued on Jun. 1, 2008, discloses a modular jack having an insulative housing defining a front mating port and a rear mounting port, an inner PCB mounted to the mounting port, a plurality of mating contacts disposed in front of the PCB, a plurality of footer pins retained to an insulative carrier, and two “T” shaped power-over-ethernet (POE) leads disposed behind the PCB. The mating contacts are retained to the insulative housing while the POE leads and footer pins are retained to the insulative carrier. The upper tail sections of the contacts and leads extending oppositely and soldered to different faces of the PCB, which requires a soldering device to solder two times.

Hence, a modular jack having a simple structure for soldering to an inner PCB is desired.

### SUMMARY OF THE INVENTION

Accordingly, an object of the present invention is to provide a modular jack having an insulative housing, an oblique inner PCB mounted on the insulative housing, a plurality of mating contacts soldered to the top edge portion of the inner PCB, a plurality of footer pins soldered to the bottom edge portion of the inner PCB, and a plurality of POE leads soldered to the top edge portion. The contacts, footer pins, and POE leads are retained on the same piece insulative housing, without requiring any other insulative carrier and associated process of assembling the footer pins and POE leads to such insulative carrier. The contacts, footer pins, and POE leads are arranged at a same side in front of the oblique inner PCB. Each of the contacts, footer pins, and POE leads has a connecting section extending along a direction substantially perpendicular to the inner PCB, and the connecting sections are soldered on a same top face of the inner PCB by one time soldering process.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a modular jack according to the present invention;

FIG. 2 is an exploded view of the modular jack shown in FIG. 1;

FIG. 3 is a further exploded view of the modular jack shown in FIG. 2;

FIG. 4 is a further exploded view of the modular jack shown in FIG. 3;

FIG. 5 is another view of the modular jack shown in FIG. 4;

FIG. 6 is another view of an insert module shown in FIG. 5;

FIG. 7 is an exploded view of an insulative housing, inner PCB, and terminals shown in FIG. 3;

FIG. 8 is an exploded view of the inner PCB and the terminals shown in FIG. 7; and

FIG. 9 is a circuit diagram of the modular jack.

### DETAILED DESCRIPTION OF THE PREFERRED EMBODIMENT

Reference will now be made in detail to the preferred embodiment of the present invention.

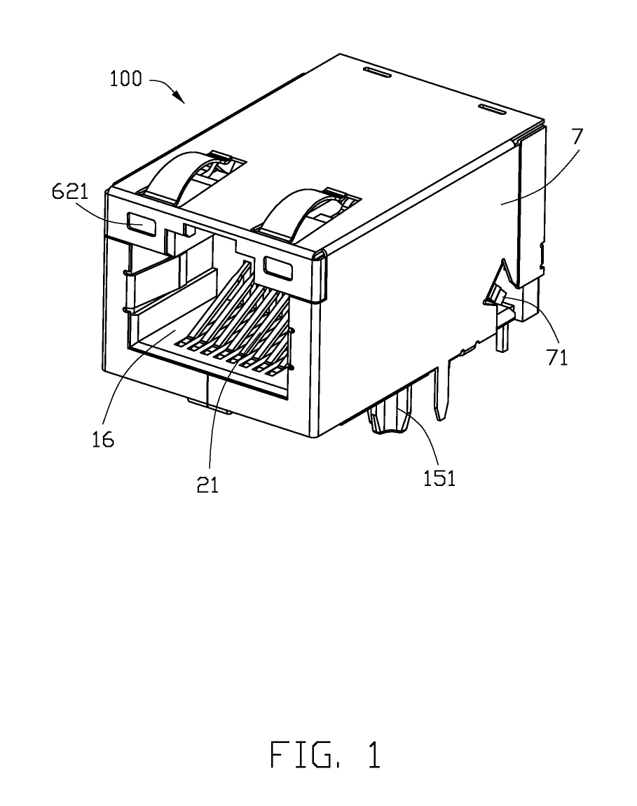

Referring to FIG. 1, a modular jack 100 according to the present invention is shown. The modular jack 100 could be mounted on a horizontal mother PCB (not shown).

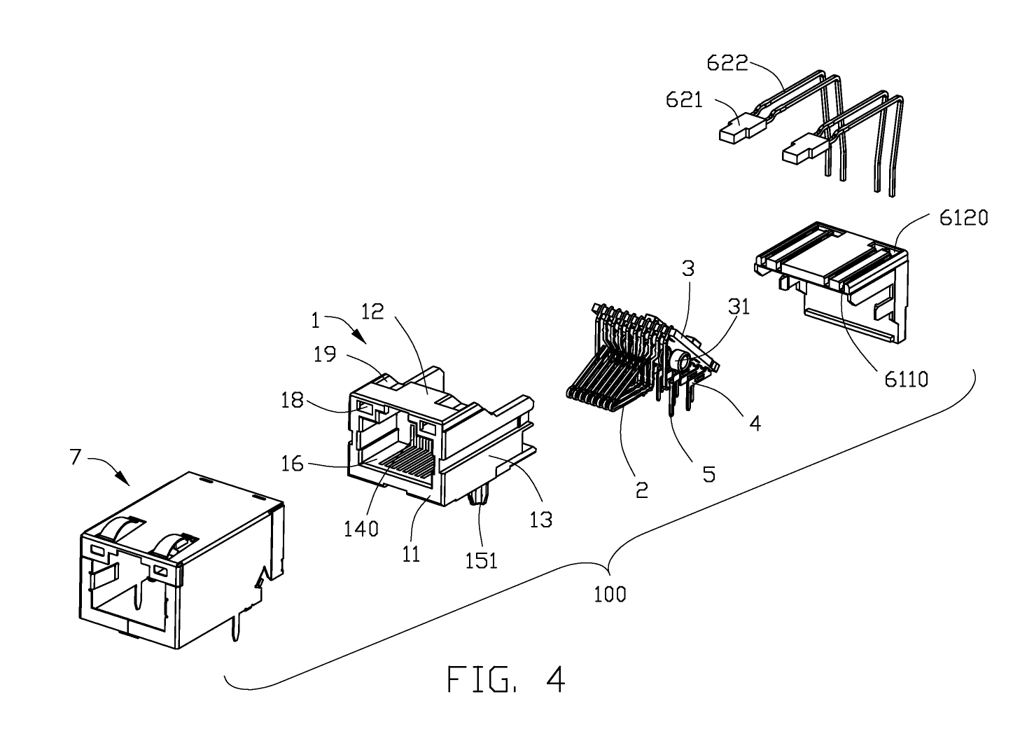

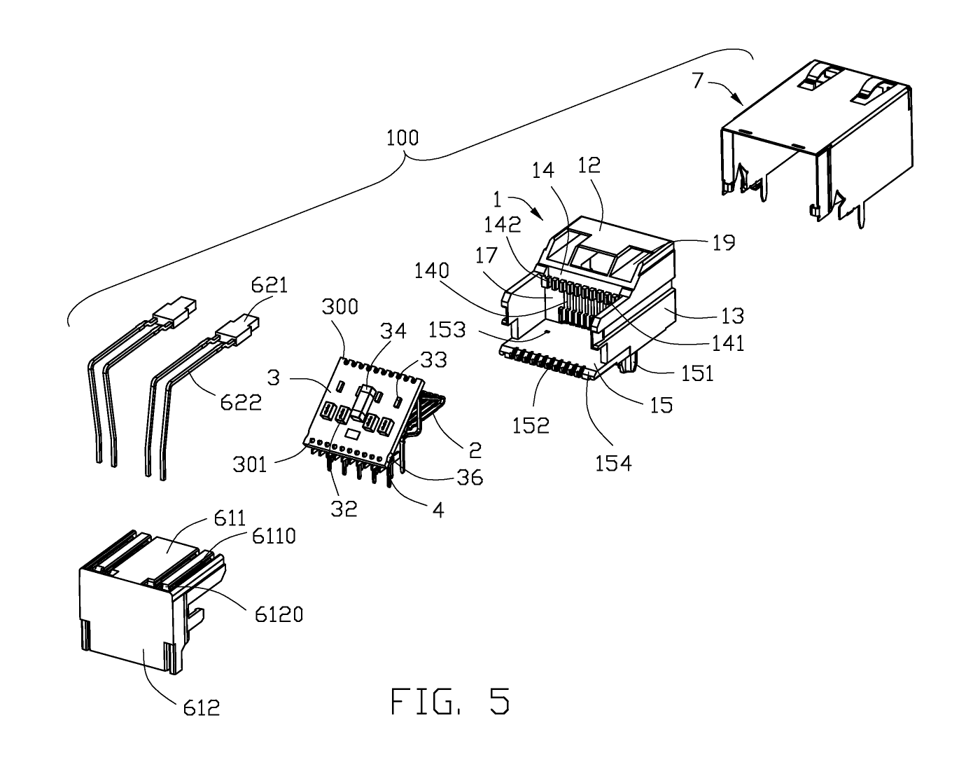

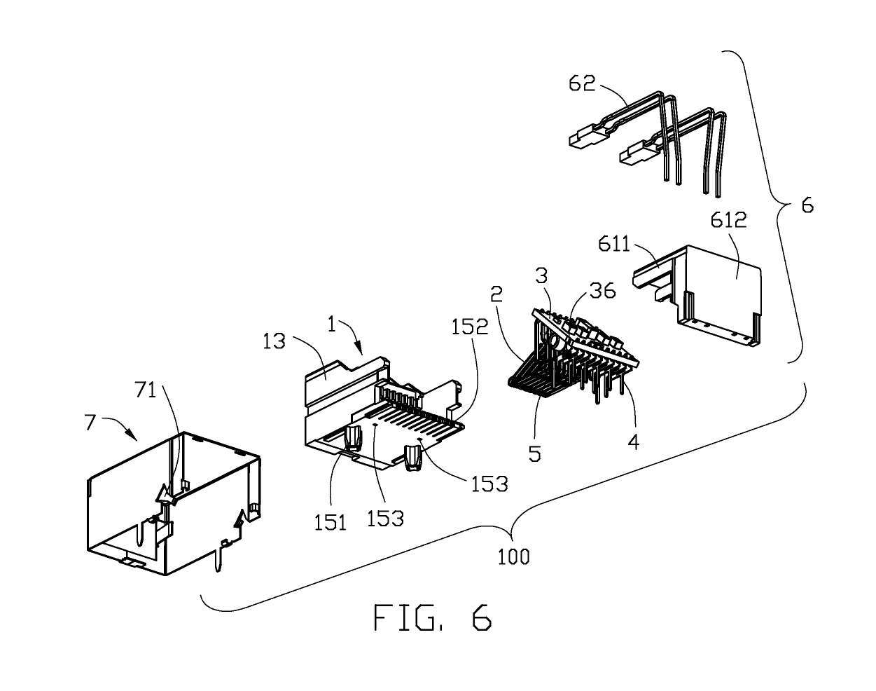

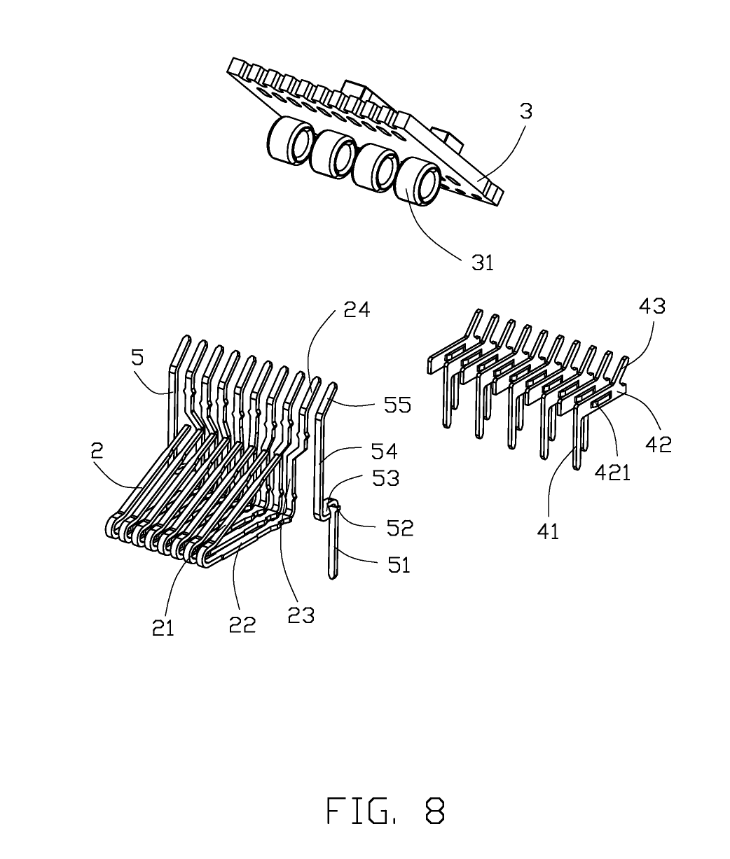

Referring to FIGS. 1-8, the modular jack 100 includes an insulative housing 1, a plurality of mating contacts 2, an inner PCB 3, a plurality of footer pins 4, a plurality of POE leads 5, a pair of light emitting component 6, and a metallic shell 7.

The insulative housing 1 has a front wall 11, a top wall 12, a bottom wall 15, two opposite side walls 13, and a middle wall 14 located between the side walls 13. The insulative housing 1 defines a front mating port 16 commonly defined by the middle wall 14 cooperating with the top and bottom walls and the side walls 14, a pair of receiving passageways 18 positioned above the mating port 16, and a rear mounting port 17 formed behind the middle wall 14 opposite to the mating port 16. The middle wall 14 has a row of backwardly projecting ribs 141 and a plurality of receiving slots 142 defined between every two adjacent ribs 141. The middle wall 14 defines a plurality of grooves 140 extending through the middle wall 14 and communicating the mating port 16 and the mounting port 17. The receiving passageways 18 extend through the top wall 12 along a front-to-back direction. The mating port 16 is configured to mate with a modular plug (not shown). The top wall 12 defines two guiding slots 19 extending therethrough along a top-to-bottom direction and communicates with the corresponding receiving passageways 18. The insulative housing 1 includes two mounting posts 151 projecting downwardly from the bottom wall 15 and inserted into through-holes of the mother PCB. The bottom wall 15 extends rearwardly beyond the middle wall 14. The bottom wall 15 defines a plurality of rear facing slot 152 on a rear end, and a plurality of apertures 153 positioned between the middle wall 14 and the rear end. A pair of platforms 154 are formed around the rear of the bottom wall 15, against which the inner PCB 3 abuts for supporting purpose. Each of the side walls 13 defines an upper cutout 131 and a lower cutout 132 located below the upper cutout 131 for a soldering equipment to move transversely.

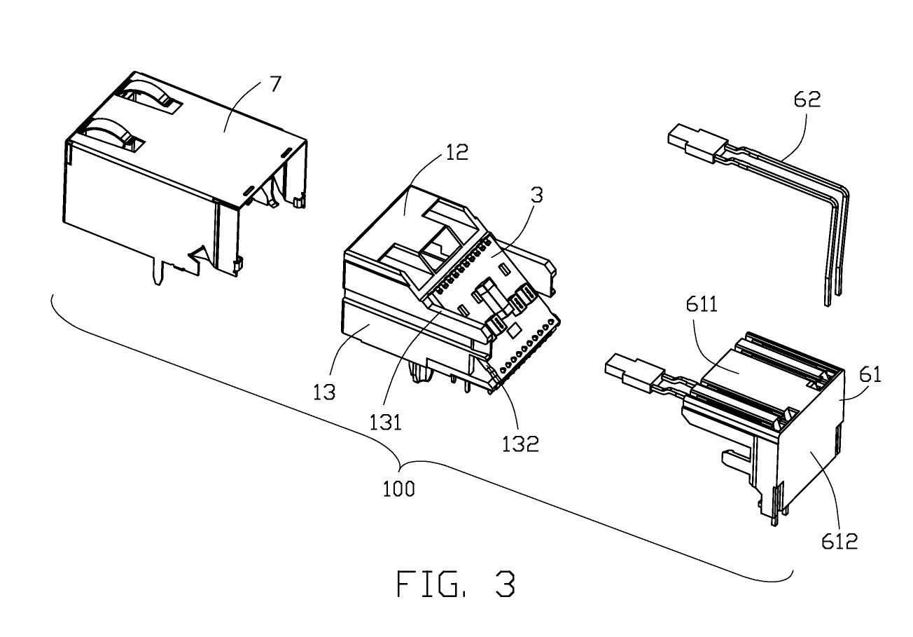

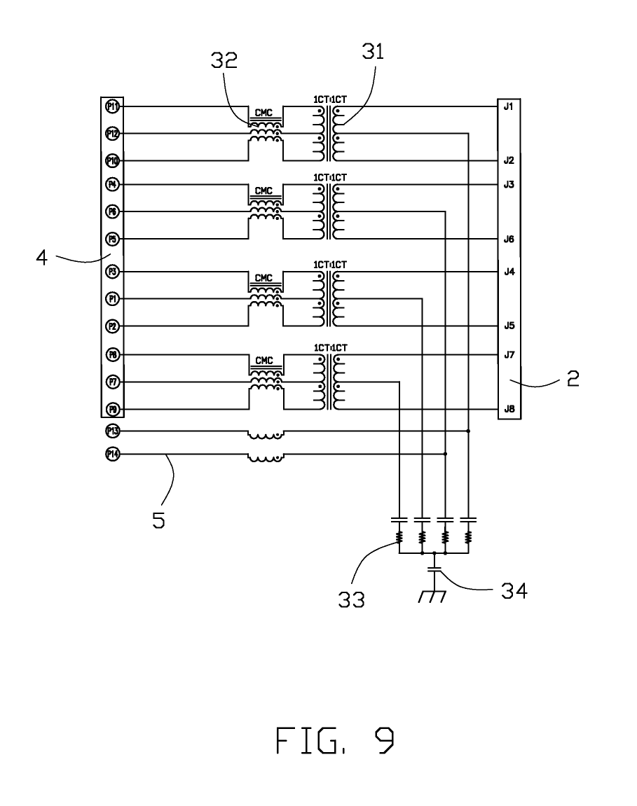

Referring to FIGS. 3, 7, and 9, the inner PCB 3 is obliquely assembled to the mounting port 17 between the two side walls 13 in a side view. The inner PCB 3 defines an upper edge region 300 distal from the bottom wall 15 of the housing 1 while proximate to the middle wall 14, and a bottom edge region 301 distal from the middle wall 14 while proximate the bottom wall 15. The inner PCB 3 has filtering components such as transformers 31, common mode chokes 32, resistors 33, and capacitors 34 mounted thereon. The contacts 2 and the POE leads 5 connect with the upper edge region 300. The footer pins connect with the bottom edge region 301. The contacts 2 electrically connect corresponding footer pins 4 through transformers 31, common mode chokes 32, and the inner PCB 3. The contacts 2 include eight contacts, the footer pins 4 include ten pins, and the POE leads 5 include at least two terminals. The two POE leads 5 are disposed at two opposite lateral sides of the contacts 2 so that remain certain gap between two adjacent footer pins 4.

Each of the contacts 2 includes a mating section 21 exposed within the mating port 16 to mate with the modular plug, a first retention section 22, 23 retained to the insulative housing 1, and a first tail section 24 extending from a rear end of the retention section 23. Each of the footer pins 4 includes a second tail section 43 connected to the bottom edge region 301, a second retention section 42 retained to the insulative housing 1, and a leg section 41 downwardly extending below the bottom wall 15 of the housing 1 for mounting to the mother PCB. Each of the POE leads 5 has a vertical portion 54 extending along the middle wall 14, a third tail section 55 connected to inner PCB 3, a horizontal section 43 extending along the bottom wall 15, an engaging portion 52 retained in the bottom wall 15, and a mounting section 51 downwardly extending beyond the bottom wall 15. The first tail sections 24 and third tail sections 55 are arranged in a same row. The inner PCB 3 defines a plurality of conductive through-holes 30 for the first, second and third tail sections 24, 43, 55 to insert therein along a direction substantially perpendicular to the inner PCB 3, so that the tail sections 24, 43, 55 are soldered on a same top face of the inner PCB 3 by one soldering process. A rear end of the top wall 12 is terminated around the middle wall 14 so as to allow the inner PCB 3 to be assembled to the tail portions in an oblique direction rather than forwardly along the back-to-front direction. The contacts 2, footer pins 4, and POE leads 5 are retained on the same piece housing 1 result in omitting an insulative carrier and a process assembling the footer pins 4 and POE leads 2 to the insulative carrier, which is assembled to the insulative housing 1.

The first retention section 22, 23 of the contact 2 includes a horizontal section 22 retained on the bottom wall 15, and a vertical section 23 extending along the middle wall 15 and retained to the backwardly projecting ribs 141 of the middle wall 14. The second retention section 42 includes a transversely protruding portion 421 for retained within the rear facing slot 152.

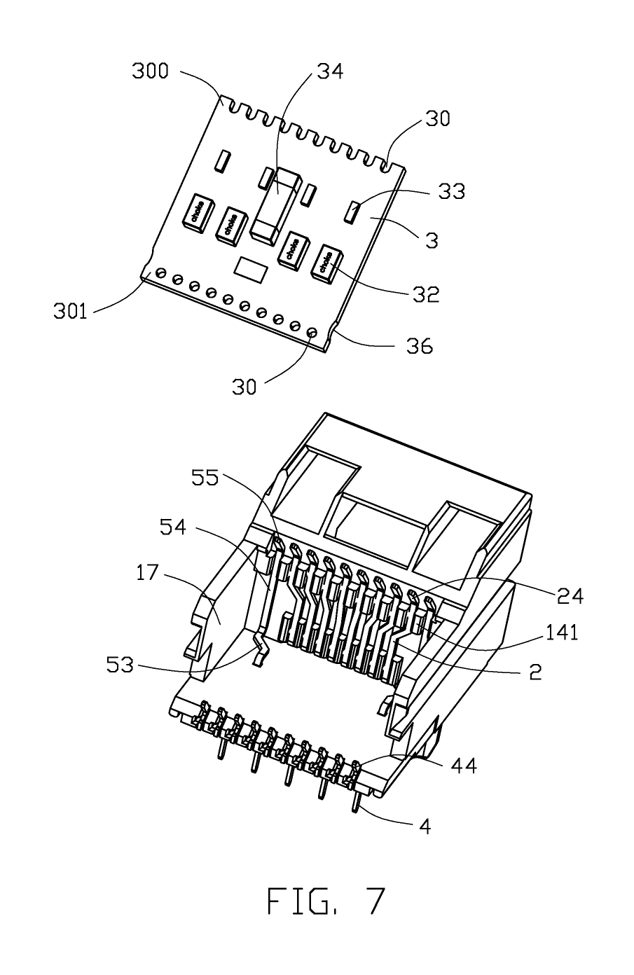

Referring to FIGS. 1 and 7, the inner PCB 3 has a grounding pads 36 on a side edge thereof, and the metallic shell 7 has a grounding tap 71 projecting inwardly to connect with the grounding pads 36. The grounding tap 71 extends across the lower cutout 132.

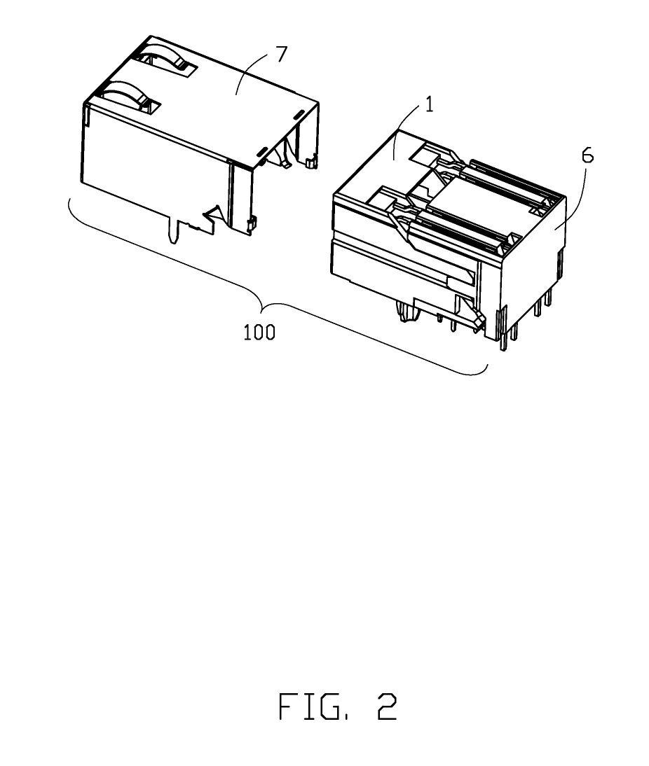

Referring to FIGS. 2-6, the light emitting light emitting component 6 includes a insulative body 61 and two light emitting diodes (LEDs) 62 retained in the insulative body. The insulative body 61 includes a horizontal arm 611 mounted to the top wall 12 of the insulative housing 1, and a vertical arm 612 assembled to the side walls 13. The horizontal arm 611 includes a receiving slot 6110 extending through a top face thereof The vertical arm includes a through-hole 6120 extending along a top-to-bottom direction. Each of LED 62 includes a lighting portion 621 received in the receiving passageways 18 of the insulative housing 1, and two conductive legs received in the receiving slot 6110 and inserted in the through-hole 6120. The guiding slots 19 guide the lighting portions to slide easily into the receiving passageways 18.

A method of assembling the modular jack 100 comprises following steps: (a) initially providing the insulative housing 1, the mating contacts 2, the footer pins 4, and the POE leads 5; (b) successively pushing the mating contacts 2 from the mounting port 17 partly into the mating port 16, the footer pins 4 into the rear facing slots 152, the POE leads 5 across the receiving slots 142 and the apertures 153; (c) mounting the inner PCB 3 along a direction perpendicular to the tail portions 24, 43, 55 and the tail portions 24, 43, 55 inserting across the conductive through-holes 30 of the PCB 3 from the bottom side of the PCB 3 to the top side of the PCB 3; (d) soldering the tail portions 24, 43, 55 to the top face of the PCB 3 along a transverse direction; (e) mounting the light emitting component 6 to the insulative housing 1; (f) assembling the metallic shell 7 to enclose the insulative housing 1 and the light emitting component 6.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. A modular jack comprising:
an insulative housing including a middle wall cooperating with opposite top and bottom walls and opposite two side walls to commonly define a front mating port, the middle wall defining a plurality of grooves;
a mounting port formed behind the middle wall opposite to the mating port, the mounting port communicating with the mating port through the plurality of grooves;
an inner PCB (printed circuit board) obliquely assembled to mounting port, the inner PCB defining an upper edge region distal from the bottom wall while proximate to the middle wall and a bottom edge region distal from the middle wall while proximate to the bottom wall;
a plurality of contacts each including a mating section exposed within the mating port to mate with a modular plug, a first retention section retained to the insulative housing, and a first tail section connecting with the upper edge region;
a plurality of footer pins each including a second retention section retained to the insulative housing, a leg section downwardly extending below the bottom wall, and a second tail section connected to the bottom edge region; and
a plurality of power-over-ethernet (POE) leads retained by the insulative housing, each of said POE leads having a third tail section connected to the inner PCB and a mounting section downwardly extending beyond the bottom wall; wherein
said inner PCB defines a plurality of conductive through-holes, the first, second, and third tail sections are inserted in the plurality of conductive through-holes along a direction substantially perpendicular to the inner PCB, and the first, second, and third tail sections are soldered on a same face of the inner PCB.

2. The modular jack as claimed in claim 1, wherein said bottom wall of the housing defines plural apertures vertically extending therethrough for inserting the POE leads.

3. The modular jack as claimed in claim 1, wherein each of said tail sections has a free end extending above the inner PCB.

4. The modular jack as claimed in claim 1, wherein the contacts include eight contacts, the footer pins include ten pins, and the POE leads include two terminals, the POE leads disposed at two opposite lateral sides of the contacts.

5. The modular jack as claimed in claim 4, wherein the first tail sections and the third tail sections are arranged in a same row.

6. The modular jack as claimed in claim 4, wherein the second tail sections of the footer pins are arranged in one row.

7. The modular jack as claimed in claim 1, wherein each of said POE leads has a vertical section extending along the middle wall, and a horizontal section extending backwardly from the vertical portion along a top face of the bottom wall.

8. The modular jack as claimed in claim 7, wherein said middle wall of the insulative housing has a row of backwardly projecting ribs and a plurality of receiving slots each defined by two adjacent ribs, the vertical sections inserted across the receiving slots.

9. The modular jack as claimed in claim 1, wherein said bottom wall extends rearwardly beyond the middle wall and has a rear end adjacent to the bottom edge region of the PCB to retain the footer pins therein.

10. The modular jack as claimed in claim 1, wherein a pair of platforms are formed around the rear of the bottom wall, the inner PCB abutting against and the pair of platforms for support.

11. The modular jack as claimed in claim 1, wherein a rear end of the top wall is terminated around the middle wall so as to allow the inner PCB to be assembled to the tail portions in an oblique direction.

12. A modular jack assembly for mounting to a outer printed circuit board, comprising:
an insulative housing seated upon the outer printed circuit board and defining a front mating port around a front face for communicating with an exterior in a front-to-back direction, and a rear mounting port around a bottom face for mounting to the outer printed circuit board in a vertical direction perpendicular to said front-to-back direction;
a plurality of contacts disposed in the mating port with deflectable mating sections for mating with a plug;
a plurality of footer pins located around the mounting port with rigid mounting sections for soldering to the outer printed circuit board;
an inner printed circuit board secured within the housing and having opposite front edge region and rear edge region wherein said contacts are soldered on the front edge region and said footer pins are soldered on the rear edge region; and
a pair of POE (power-over-ethernet) leads associated with the inner printed circuit board and adapted to be located between the inner printed circuit board and the outer printed circuit board in the vertical direction; wherein
each of said POE leads has an upper ends soldered to the inner printed circuit board and a lower ends for soldering to the outer printed circuit board.

13. The modular jack as claimed in claim 12, wherein the POE leads are located adjacent to the front edge region and far from the rear edge region.

14. The modular jack as claimed in claim 12, wherein the inner printed circuit board is oblique to both the mating port and the mounting port, and all the contacts, the footer pins and the POE leads are connected to the inner printed circuit board in a perpendicular manner.

15. The modular jack as claimed in claim 14, wherein each of said contacts defines a thickness direction extending in a vertical plane defined by the front-to-back direction and the vertical direction while each of said footer pins defines another thickness direction constantly extending in a transverse direction perpendicular to both said front-to-back direction and said vertical direction.

16. The modular jack as claimed in claim 15, wherein each of said footer pins includes a retention section extending along the front-to-back direction, and a tail section upwardly and obliquely extending from an area in front of a rear end of the retention section so as to be soldered to the inner printed circuit board in the perpendicular manner.

17. The modular jack assembly as claimed in claim 12, wherein the housing further includes a bottom wall in which the footer pins are retained, and said bottom wall further forms a pair of though holes through which the pair of POD leads downwardly extend, respectively, and said pair of holes are essentially located between the contacts and the footer pins in the front-to-back direction.

18. A modular jack assembly for mounting to a outer printed circuit board, comprising:
an insulative housing seated upon the outer printed circuit board and defining a front mating port around a front face for communicating with an exterior in a front-to-back direction, and a rear mounting port around a bottom face for mounting to the outer printed circuit board in a vertical direction perpendicular to said front-to-back direction;
a plurality of contacts disposed in the mating port with deflectable mating sections for mating with a plug;
a plurality of footer pins located around the mounting port with rigid mounting sections for soldering to the outer printed circuit board; and
an inner printed circuit board secured within the housing and having opposite front edge region and rear edge region wherein said contacts are soldered on the front edge region and said footer pins are soldered on the rear edge region; wherein
the inner printed circuit board is oblique to both the mating port and the mounting port, and both the contacts and the footer pins are connected to the inner printed circuit board in a perpendicular manner; wherein
each of said contacts defines a thickness direction extending in a vertical plane defined by the front-to-back direction and the vertical direction while each of said footer pins defines another thickness direction constantly extending in a transverse direction perpendicular to both said front-to-back direction and said vertical direction.

19. The modular jack assembly as claimed in claim 18, wherein each of said footer pins includes a retention section extending along the front-to-back direction, and a tail section upwardly and obliquely extending from an area in front of a rear end of the retention section so as to be soldered to the inner printed circuit board in the perpendicular manner.

20. The modular jack assembly as claimed in claim 18, further including a pair of leads associatively solder upon the inner printed circuit board with corresponding bottom ends extending downwardly beyond the mounting port for soldering to the outer printed circuit board.
